(19) United States
(12) Patent Application Publication
(10) Pub. No.: US 2021/0287256 A1
(43) Pub. Date: Sep. 16, 2021

(54) BIDDING TO ADVERTISE AGAINST ON-SITE PURCHASES

(71) Applicant: Lundy SMITH, Gardena, CA (US)

(72) Inventor: Lundy SMITH, Gardena, CA (US)

(21) Appl. No.: 16/820,372

(22) Filed: Mar. 16, 2020

(51) Int. Cl. G06Q 30/02

(52) U.S. Cl. CPC G06Q 30/0275; G06Q 30/0277; G06Q 30/0252; G06Q 30/0269

(57) ABSTRACT

A method of monetizing interactions between a user and a product contemplates obtaining product-related information further to a device of the user scanning a product identifier and assigning at least a first advertiser and second advertiser to an advertising space auction. After determining a winning advertiser from among at least the first and second advertisers, the method contemplates receiving an advertisement from the winning advertiser and combining the product-related information and the advertisement into a response. The response is then sent to the device of the user.

### FIELD OF THE INVENTION

The field of the invention is advertisement auction services.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

Conventional advertisement systems provide advertisement opportunities to advertisers on a broad level. Often, advertisements are displayed for extended periods of time in places where advertisers predict they will receive the most views and receive the most return on investment. Though advertisements have become more tailored using additional data, such as user search histories, advertisements are still limited to predicting what a user might want to purchase at any given time. As such, methods enabling quick advertisement response based on the current conditions of a user could advantageously allow advertisers to dynamically adapt to those current conditions. Such methods could also reduce expenses on advertisements that are unlikely to reach target audiences and increase the overall efficiency of advertising systems.

U.S. Pat. No. 9,881,289 to Cummins teaches an advertising system that collects user data and uses that data to predict what a user might want to see advertised in a search engine. However, Cummins fails to teach an advertising system that automatically responds to a user's taking steps to choose a particular product. Instead, Cummins merely attempts to approximate what a user's needs might be and takes a best guess at which advertisements might be most relevant to the user.

U.S. Pat. No. 9,129,313 to Farmer teaches a system of bid-time decisions based upon probability scores for advertisers for online advertising campaigns. Farmer attempts to predict how much an online advertisement is worth to an advertiser, and correspondingly submits a bid reflecting that perceived value. However, Farmer, like Cummins, attempts to predict user behavior, and any corresponding value of an advertisement to an advertiser. Here again, Farmer fails to teach a system that requests and receives bids from relevant advertisers, at or substantially at the point in time that a user shows interest in a particular item or service, such as when a user scans a particular product in a grocery store with their smartphone.

Thus, there is still a need for systems and methods that allow advertisers to bid on advertisement space, at or near the time a user shows interest in a particular product or service.

These and all other publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems, and methods for requesting bids from advertisers at or near the time a user is showing interest in a product or service, and then sending winning advertisements to the user.

Advertisements can be in any form. For example, advertisements can include instructions for use of a scanned product, promotional coupons for a scanned product, coupons for competing products, and promotions for products related to the scanned product.

The present invention contemplates selecting advertisers based on at least one of a physical proximity metric and a market overlap metric. However, advertisers can be selected using any method known in the art.

The inventive subject matter also contemplates embedding the advertisement with the product-related information. It is further contemplated that product-related information can be tailored based on various metrics including, for example, user characteristics, product characteristics, environmental metrics, and any combination thereof.

User characteristic can include, but are not limited to, a user age, a user gender, a user purchase history, and a user membership in a loyalty program. Product characteristics can include, but are not limited to, a product cost, a product quantity per unit, and a product remaining shelf life. Environmental characteristics can include a time of day, a weather condition, and a special event.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a functional block diagram illustrating a distributed data processing environment.

FIG. 2 is a flowchart illustrating a method for generating product-related information using auction module as a function of user metrics, product metrics, and environmental metrics.

FIG. 3 is a flowchart illustrating a method for requesting bids for displaying an advertisement to a user based on a scanned product code.

FIG. 4 is a schematic depicting a method of generating determining a highest bid and sending an advertisement for the highest bidder to a user device.

FIG. 5 depicts a block diagram of components of the server computer executing the programming generation module within the distributed data processing environment of FIG. 1.

FIG. 6 depicts an illustrative example of a user scanning a particular product to cause one or more advertisers to bid for a spot on a graphical user interface on the user's smartphone.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

In interpreting descriptions in this Specification, groupings of alternative elements or embodiments of the inventive subject matter are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Various objects, features, aspects and advantages of the inventive subject matter will become more apparent from the following detailed description of preferred embodiments, along with the accompanying drawing figures in which like numerals represent like components.

It should be noted that any language directed to a computer or a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

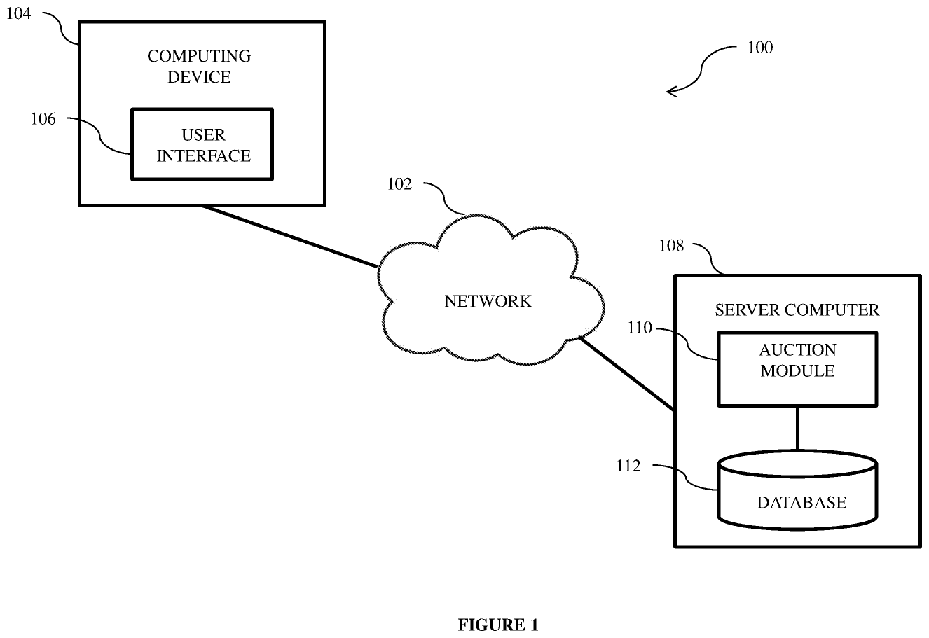

FIG. 1 is a functional block diagram illustrating a distributed data processing environment.

The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 104 and server computer 108, interconnected over network 102. Network 102 can include, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between computing device 104, server computer 108, and any other computing devices (not shown) within distributed data processing environment 100.

It is contemplated that computing device 104 can be any programmable electronic computing device capable of communicating with various components and devices within distributed data processing environment 100, via network 102. It is further contemplated that computing device 104 can execute machine readable program instructions and communicate with any devices capable of communication wirelessly and/or through a wired connection. Computing device 104 includes an instance of user interface 106.

User interface 106 provides a user interface to auction module 110. Preferably, user interface 106 comprises a graphical user interface (GUI) or a web user interface (WUI) that can display one or more of text, documents, web browser windows, user option, application interfaces, and operational instructions. It is also contemplated that user interface can include information, such as, for example, graphics, texts, and sounds that a program presents to a user and the control sequences that allow a user to control a program.

In some embodiments, user interface can be mobile application software. Mobile application software, or an “app,” is a computer program designed to run on smart phones, tablet computers, and any other mobile devices.

User interface 106 can allow a user to register with and configure auction module 110 (discussed in more detail below) to enable a user to interface with auction module 110. It is contemplated that user interface 106 can allow a user to provide any information to auction module 110.

Server computer 108 can be a standalone computing device, a management server, a web server, a mobile computing device, or any other computing system capable of receiving, sending, and processing data.

It is contemplated that server computer 108 can include a server computing system that utilizes multiple computers as a server system, such as, for example, a cloud computing system.

In other embodiments, server computer 108 can be a computer system utilizing clustered computers and components that act as a single pool of seamless resources when accessed within distributed data processing environment 100.

Database 112 is a repository for data used by auction module 110. In the depicted embodiment, auction module 110 resides on server computer 108. However, database 112 can reside anywhere within a distributed data processing environment provided that auction module 110 has access to database 112.

Data storage can be implemented with any type of data storage device capable of storing data and configuration files that can be accessed and utilized by server computer 108. Data storage devices can include, but are not limited to, database servers, hard disk drives, flash memory, and any combination thereof.

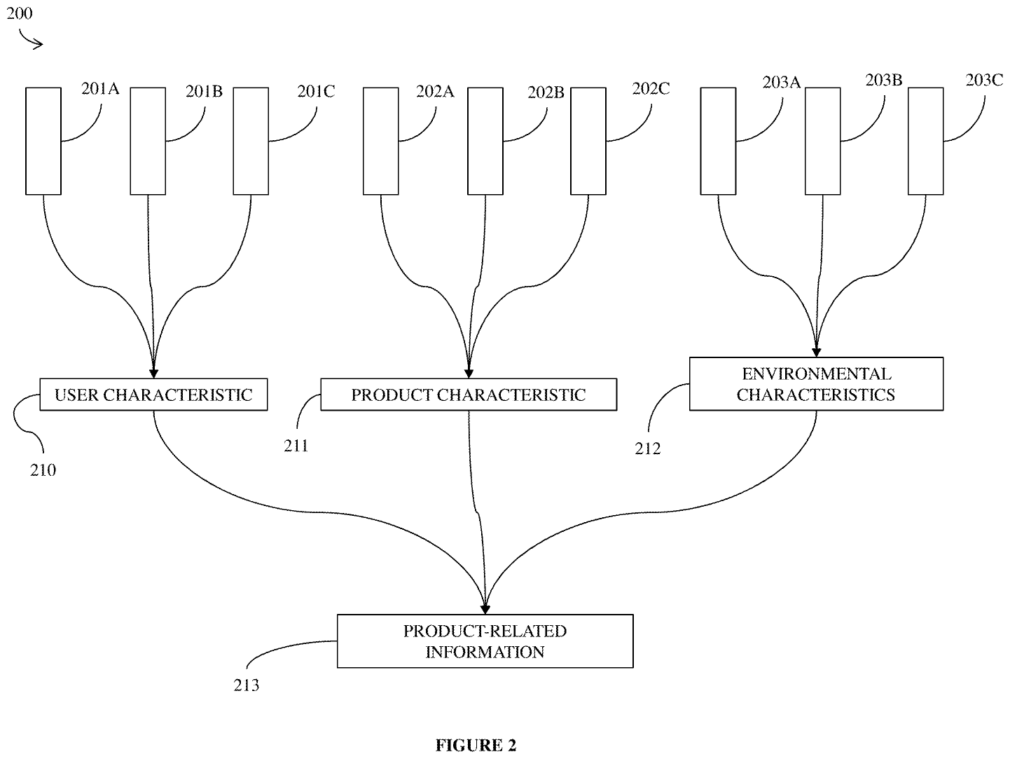

FIG. 2 is a flowchart illustrating a method for generating product-related information using auction module 110 as a function of user metrics 201A-C, product metrics 202A-C, and environmental metrics 203A-C.

User characteristics 210 can be any one or more characteristics associated with an end-user.

User metrics 201A-C are subcategories of user characteristics. For example, user sub-characteristics 201A-C can be selected from a group of sub-characteristics comprising an age metric, a gender metric, a purchase metric, and a membership metric.

An age metric can include any characteristics that are at least in part associated with a user's age. It is contemplated that age metrics comprise information on the relationship between one or more age groups and a given product and/or service. For example, auction module 110 can use age metrics to correlate an increased demand for nutritional supplements and vision assistive products with users between the ages of 55 and 95. In another example, auction module 110 can use age metrics to limit the promotion of alcohol to users over the legal drinking age based on their respective local laws.

Gender metrics can include any gender-based correlation between particular products and/or services and a gender classification. For example, auction module 110 can determine that a user is female and correspondingly determine that a promotional discount on women's athletic wear is more likely to be redeemed by the user. In another example, auction module 110 can determine that a user is male and correspondingly determine that a promotional discount on male hygiene products is more likely to be redeemed by the user. It is contemplated that gender may be considered a non-binary construct and can instead include any combination of classifications and sub-classifications of gender.

Purchase metrics can include any characteristics associated with a user's purchasing behavior. It is contemplated that purchase metrics include a user's purchase history, which can be used by auction module 110 to analyze a user's purchase behavior, extract any purchasing patterns of a user, and predict future user purchasing behavior. For example, auction module 110 can determine what a user is likely to buy during the start of the winter season based on the user's purchase history in the previous three years. In a related example, auction module 110 can determine that the user is unlikely to buy prenatal care products, as bought in the previous winter season, and instead purchase diapers and baby essentials in the coming season.

Product characteristics 211 can include any product metrics 202A-C can include any definable characteristics of a product. For example, product metrics 202A-C include, but are not limited to, size, color, price, availability, and shelf life. In some embodiments, product metrics 202A-C are variable. For example, the price of a particular item can go up and down based on the inventory level of that item. In another embodiment, product metrics 202A-C dynamically change as a function of various factors. For example, pricing of a product can change based on the time of the month, such that it is cheaper during less busy times of the month and more expensive during busier times.

In some embodiments, auction module 110 can determine what a user is likely to buy based on the characteristics of the products themselves. For example, auction module 110 can determine that the user primarily purchases red colored items for kitchenware and predict that the user will continue to purchase red kitchenware in the future. In another example, auction module 110 can determine that the user specifically purchases latex-free items and predict that the user will continue to avoid latex.

Membership metrics can identify which organization (e.g., store loyalty programs) that a user belongs to, which can, in turn, be used to trigger certain conditions. For example, conditions can include, but are not limited to, provision of promotional credit, access to financial resources, and incentives (e.g., coupons, bulk sale deals, etc.). In one embodiment, auction module 110 dynamically adjusts the triggered conditions based on the parameters associated with a purchase. For example, auction module 110 can determine that a user that has repeatedly purchased the same product from the same retailer is eligible for an increased incentive to continue their current purchasing behavior.

Environmental characteristics 212 can include any environmental metrics 203A-C can include any characteristic of a user's environment.

In one embodiment, environmental metrics 203A-C include temporal considerations, such as a time of day, seasonality, or a special event.

A time of day can include, for example, morning, afternoon, or evening. In another example, the time of day can be divided into multiple categories, each with a specific time frame defining the time of day.

A special event can be, for example, an upcoming sporting event, such as the Super Bowl, or a holiday, such as Thanksgiving. For example, if a sporting event is occurring in the next week, auction module 110 can select incentives for the purchase of fried products or snack products. In another example, auction module 110 can generate an incentive for the purchase of baked products will be generated when Thanksgiving is within two weeks of the current date.

In another embodiment, environmental metrics 203A-C include geographic considerations. For example, environmental metrics 203A-C can include weather conditions, seasonality based on geography, local laws and regulations, and geographic preferences tied to particular regions.

Geographic preferences can include any patterns or correlations associated with a particular region and its general preferences and/or needs for particular products and services.

For example, a snowy region can have a much higher need for snow tires. In another example, southern region of the United States can be highly correlated with the sales of herbs found in Cajun spice. In yet another example, the city of Hollywood in California can correlate to higher spending on beauty services and products, which can further be narrowed down to the types of beauty services and products purchased based on the time of year.

Weather conditions can include, for example, storms, heatwaves, and prolonged periods of cold weather. For example, if a storm is approaching the area in which the user's device is located, auction module 110 can select incentives and promotional discounts for tea products, baking products, and/or hot food/beverage products.

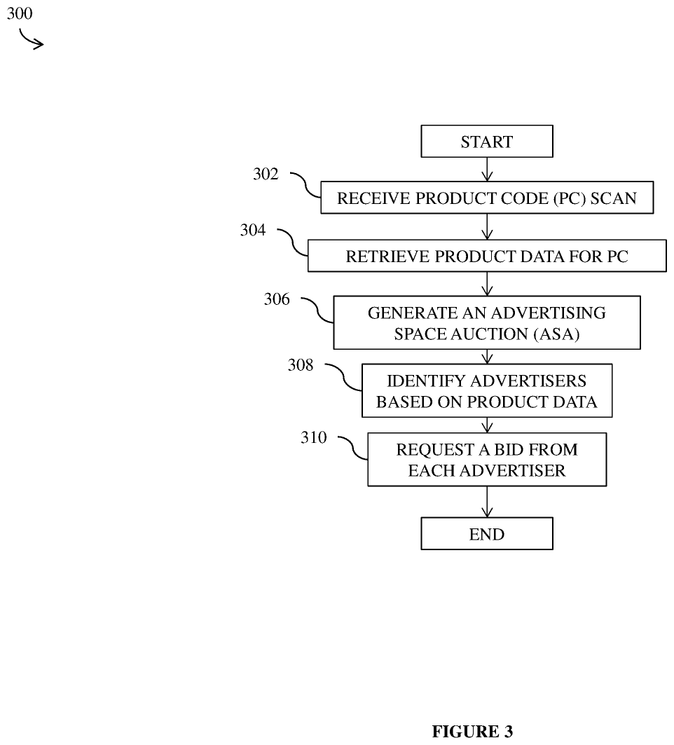

FIG. 3 is a flowchart illustrating a method for requesting bids for displaying an advertisement to a user based on a scanned product code.

Auction module 110 receives a product code (PC) scan (step 302).

In one embodiment, auction module 110 receives a product code scan through a wireless scanning module. For example, auction module 110 can receive a scan of an RFID tag on a supermarket shelf from an RFID reader of a user's smart phone. In another example, auction module 110 can receive a product scan acquired through a Bluetooth™ connection. In yet another example, auction module 110 can receive a product scan acquired through a WiFi™ connection.

In another embodiment, auction module 110 receives a product code scan through an imaging modality. Imaging modalities can include any combinations software and/or hardware used to capture and process an image. For example, auction module 110 can receive a scan of a QR code from a camera of a smartphone.

However, it is contemplated that auction module 110 can receive a product code scan in any manner known in the art.

Auction module 110 retrieves product data associated with PC (step 304).

Product data can include any information about associate with product metrics 202A-C.

For example, if product metrics for a loaf of bread include a manufacturer, a shelf-life, and nutrition information, then the product data can include the name of a local bakery, a shelf-life of 2 weeks, and a calorie content of 100 calories per serving.

In another example, if product metrics for an automobile include a manufacturer, a color, and a power source, then the product data for an electric car can include a specific car brand, the color red, and an electrical power source. In yet another example, if product metrics for a laptop computer include a processor type, a battery life, and a price, then the product data can include a quad-core processor, a battery life of 9-11 hours, and a price of $949.00.

Auction module 110 generates an advertising space auction (ASA) (step 306).

An ASA can include any advertisers interested in sending their advertisement to a user's phone. It is contemplated that the ASA creates a marketplace where advertisers can bid for direct-to-user ads. For example, auction module 110 can create an ASA to send an advertisement to be displayed on the smart phone of a particular individual. In another example, auction module 110 can create an ASA to send an advertisement to a particular group of individual, such as an advertisement that is sent to teenagers when they enter the store between the hours of 3-5 pm when school typically gets out.

It is also contemplated that the advertising space auction can create a marketplace for publicly displayed ads. For example, auction module 110 can create an advertising space auction for a display inside of a supermarket that displays a new advertisement every 10 minutes. Advertisers knowing that their products are sold at the highest rate during the dinner hour can bid for publicly displayed advertisements in a supermarket.

Auction module 110 identifies advertisers associated with the retrieved product data (step 308).

Auction module 110 can identify advertisers associated with the product data from a list of advertisers stored on a database, such as database 112. For example, if the retrieved product data is for bulk diapers, then auction module 110 can filter a list of advertisers to identify companies selling baby products. It is contemplated that the advertisers contacted may not be directly associated with the scanned product. For example, advertisers for baby formula may be selected to participate in the ASA when diapers are scanned in order to encourage the consumer to buy a particular brand of baby formula along with their diaper purchase.

It is alternatively and additionally contemplated that auction module 110 can be directly associated with the scanned product. For example, advertisers for a competing baby formula company can be invited to bid for an advertisement promoting their product when their competitor's baby formula is scanned by a user.

In some embodiments, auction module 110 requests input from a user. For example, auction module 110 can give a user a set of choices for a related topic associated with a product. In a more specific example, auction module 110 can give the user an option to select an icon requesting good wine pairings with a food item or a second icon requesting additional products for a meal incorporating the selected product. In another example, auction module 110 can provide additional product information and/or connections to other merchandise carried in the business.

Auction module 110 requests a bid from each identified advertiser (step 310).

It is contemplated that auction module 110 can request a bid from each identified advertiser in any manner known in the art. In one embodiment, auction module 110 requests bids from each identified advertiser automatically. For example, auction module 110 can automatically send a request to each advertiser as soon as auction module 110 identifies the relevant advertisers. In other embodiments, auction module 110 can receive a list from a third party (e.g., third party company, etc.) of advertisers to request bids from.

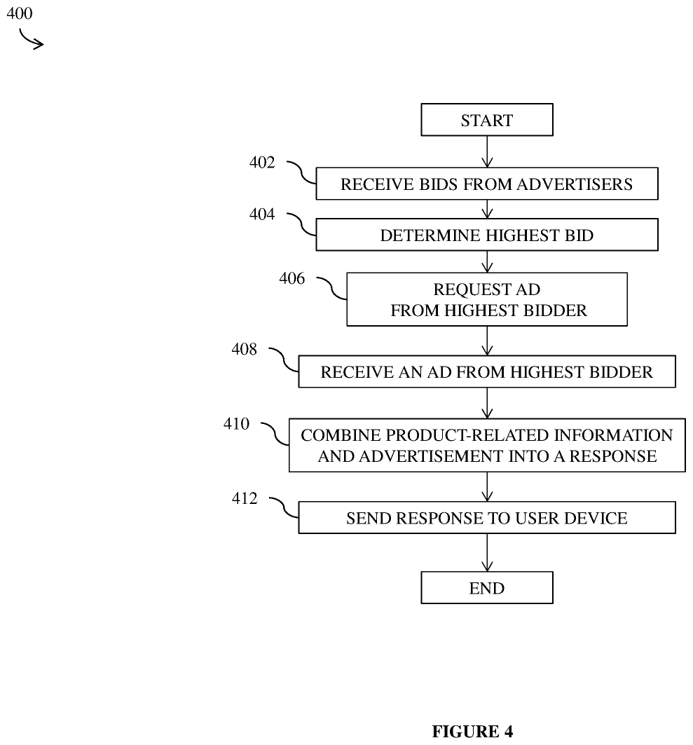

FIG. 4 is a schematic depicting a method of determining a highest bid and sending an advertisement for the highest bidder to a user.

Auction module 110 receives bids from advertisers (step 402).

Auction module 110 can receive bids in any manner known in the art. In some embodiment, auction module 110 receives bids directly from an advertiser. For example, each individual company can send separate bids in an ASA. In other embodiments, auction module 110 can receive bids via a separate entity. For example, each advertiser can submit one or more parameters associated with their bids (e.g., bids on particular products, maximum bids, minimum bids, bidding during a specific time frame, etc.), which can then be weighed relative to any other bids by auction module 110. Auction module 110 can determine the respective bids for multiple advertisers based on the application of each advertisers' parameters.

Auction module 110 determines a highest bid (step 404).

It is contemplated that auction module 110 can determine the highest bid in any manner known in the art. Further, it is contemplated that auction module 110 can designate a bid less than the highest bid as the highest bid in certain situations. For example, auction module 110 can determine that the highest bidding advertiser has a significant outstanding balance and opt to make the second highest bidding advertiser the highest bid for an advertisement opportunity.

In another example, auction module 110 can determine that the highest bidder is subject to external restrictions on advertising. External restrictions can include, but are not limited to, ethical concerns, restrictions by government entities, and contractual obligations preventing an advertiser from bidding or advertising in particular spaces. For example, a store with its own brand and line of products may limit advertisements in its space to non-competitors. In another example, a store with an agreement not to compete in a particular geographic region may be restricted from advertising in a store in that space. In yet another example, a state law preventing the advertisement of tobacco in any form can prevent a tobacco company from advertising their products in a store.

Auction module 110 requests an advertisement from the highest bidder (step 406).

In one embodiment, auction module 110 can request an advertisement from the highest bidder directly. For example, auction module 110 can request an advertisement to send to a user from a car company that won the advertisement bid for a particular display.

In other embodiments, auction module 110 automatically retrieves an advertisement from the highest bidder. For example, auction module 110 can access a remote database containing pre-submitted advertisements from the advertisers, which can then be accessed by auction module 110 whenever an advertiser submits the highest bid.

Auction module 110 receives an advertisement from the highest bidder (step 408).

Advertisements can include any type of information associated with the advertiser. For example, advertisements can include additional coupons for related product. In another example, advertisements can include additional information about a product, such as, for example, a recipe for grilled cheese for an advertisement associated with a can of tomato soup.

Auction module 110 combines product information and the received advertisement to produce a response (step 410).

It is contemplated that auction module 110 can combine any information in any configuration known in the art into a response. In one embodiment, the response can include interactive elements, such as buttons that hyperlink to description of the product and/or related products. For example, an advertisement for a coffee machine can come with a clickable ad for replacement coffee filters and bulk coffee beans.

In another embodiment, the response can include only static elements. For example, the advertisement can be a simple logo or other pictorial representation of a product manufacturer.

Auction module 110 sends the response to a user device (step 412).

It is contemplated that auction module 110 can send the response to the user device using any medium known in the art. For example, auction module 110 can send the response to a smartphone over a cellular data connection. In another example, auction module 110 can send the response through short-form wireless communications mediums, such as near-field communications, Bluetooth™, and WiFi™.

In some embodiments, the user responds to the response to initiate additional actions. For example, auction module 110 can receive a confirmation that the user desires the advertised product, and auction module 110 can directly put in an order for the product. The order for the product can be delivered in any manner known in the art. For example, the product order from a user's smart phone can be sent directly to store employees for purchase at a retail checkout in the same store. In another example, the product order from a user's smart phone can be shipped from the store or any other location directly to a separate location, such as a user's house.

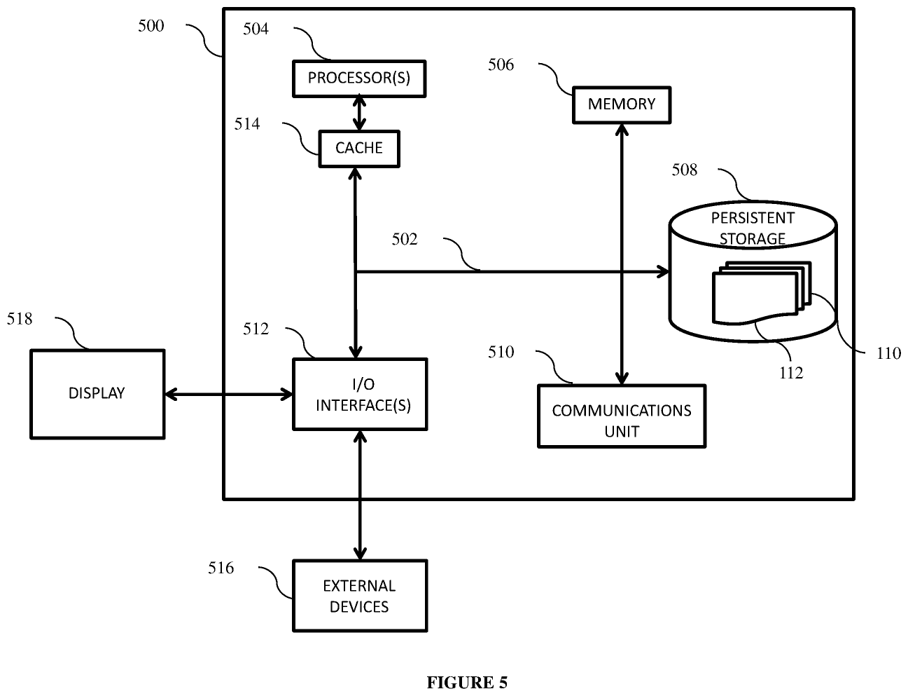

FIG. 5 depicts a block diagram of components of the server computer executing the programming generation module within the distributed data processing environment of FIG. 1.

In one embodiment, the computer includes processor(s) 504, cache 514, memory 506, persistent storage 508, communications unit 510, input/output (I/O) interface(s) 512, and communications fabric 502.

Communications fabric 502 provides a communication medium between cache 514, memory 506, persistent storage 508, communications unit 510, and I/0 interface 512. Communications fabric 502 can include any means of moving data and/or control information between computer processors, system memory, peripheral devices, and any other hardware components.

Memory 506 and persistent storage 508 are computer readable storage media. As depicted, memory 506 can include any volatile or non-volatile computer storage media. For example, volatile memory can include dynamic random access memory and/or static random access memory. In another example, non-volatile memory can include hard disk drives, solid state drives, semiconductor storage devices, a read-only memory (ROM), an erasable programmable read-only memory (EPROM), a flash memory, and any other storage medium that does not require a constant source of power to retain data.

In one embodiment, memory 506 and persistent storage 508 are random access memory and a hard drive hardwired to computing device 104, respectively. For example, computing device 104 can be a computer executing the program instructions of context engine 110 communicatively coupled to a solid state drive and DRAM.

In some embodiments, persistent storage 508 is removable. For example, persistent storage 508 can be a thumb drive or a card with embedded integrated circuits.

Communications unit 510 provides a medium for communicating with other data processing systems or devices, including data resources used by computing device 104. For example, communications unit 510 can comprise multiple network interface cards. In another example, communications unit 510 can comprise physical and/or wireless communication links.

It is contemplated that context engine 110, database 112, and any other programs can be downloaded to persistent storage 508 using communications unit 510.

In a preferred embodiment, communications unit 510 comprises a global positioning satellite (GPS) device, a cellular data network communications device, and short to intermediate distance communications device (e.g., Bluetooth®, near-field communications, etc.). It is contemplated that communications unit 510 allows computing device 104 to communicate with other computing devices 104 associated with other users.

Display 518 is contemplated to provide a mechanism to display information from context engine 110 through computing device 104. In preferred embodiments, display 518 can have additional functionalities. For example, display 518 can be a pressure-based touch screen or a capacitive touch screen.

In yet other embodiments, display 518 can be any combination of sensory output devices, such as, for example, a speaker that communicates information to a user and/or a vibration/haptic feedback mechanism. For example, display 518 can be a combination of a touchscreen in the dashboard of a car, a voice command-based communication system, and a vibrating bracelet worn by a user to communicate information through a series of vibrations.

It is contemplated that display 518 does not need to be physically hardwired components and can, instead, be a collection of different devices that cooperatively communicate information to a user.

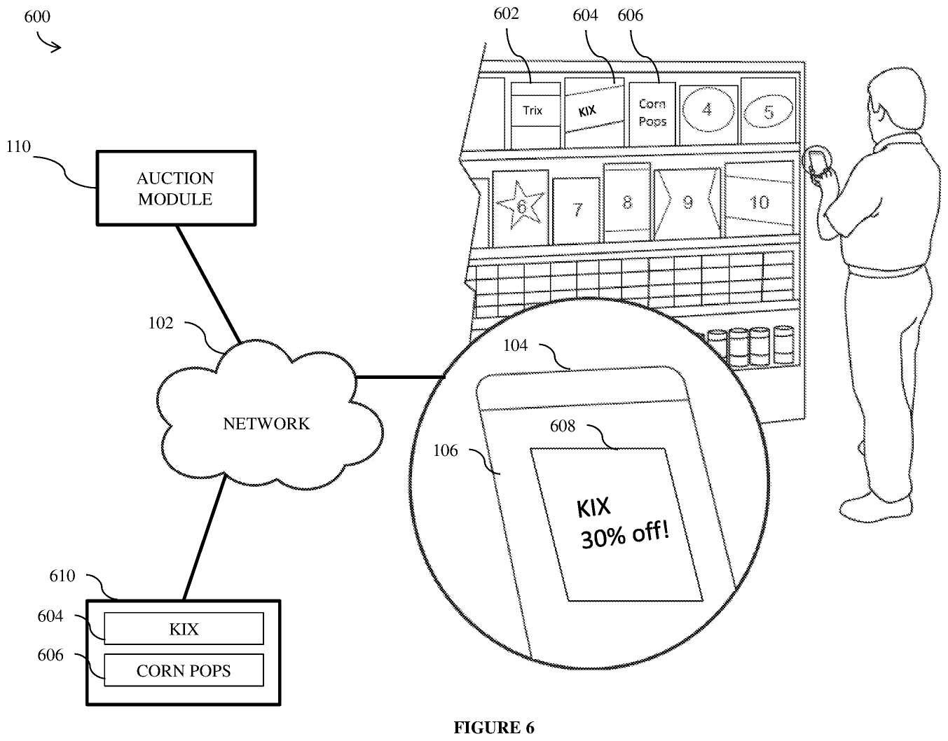

FIG. 6 depicts a use case 600 of a user scanning a product 602, such as Trix in the depicted embodiment, to cause auction module 100 to solicit bids from advertisers 610 for a spot on ad section 608 on user interface 106 of computing device 104. Advertisers 610 are depicted as including advertiser 604 and advertiser 606, which are depicted as KIX and Corn Pops, respectively.

It is contemplated that the bids can be solicited and received from any advertising entity, regardless of a direct connection with the scanned product.

In the depicted use case 600, a user scans product 602 (Trix) which causes auction module 110 to request bids from competing advertisers 604 and 606 (KIX and Corn Pops) associated with competing products on the same shelf as product 602. Based on the bids received, auction module 110 causes an advertisement of the winning bidder to be displayed on user interface 106 via ad section 608.

In other embodiments, advertisers 604 and 606 can be associated with products that are not in the same category as product 602. For example, if product 602 is a box of cereal, then advertisers 604 and 606 can be different milk suppliers.

In yet other embodiment, advertisers 610 can include an advertiser associated with product 602. For example, auction module 110 can solicit a bid from a company associated with the scanned product itself.

As used herein, a user can include any entity including, for example, individuals, groups of individuals, corporate entities, or any other definable entity.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method of monetizing an interaction in which a user utilizes a user device to scan a product identifier associated with a product, comprising:
obtaining product-related information from the product identifier;
analyzing one or more user characteristics, wherein the one or more user characteristics include historical user purchase behavior;
extracting at least one purchasing pattern of a user;
determining a predicted future user purchasing behavior based on the extracted at least one purchasing pattern of the user;
filtering one or more advertisers based on the predicted future user purchasing behavior to select one or more user-relevant advertisers, wherein the one or more user-relevant advertisers at least includes a first advertiser and a second advertiser;
assigning at least the first advertiser and the second advertiser to an advertising space auction;
determining a winning advertiser from among at least one of the first advertiser and the second advertiser;
receiving an advertisement associated with the winning advertiser;
combining (a) at least some of the product-related information and (b) the advertisement into a response; and
sending the response to the device of the user.

2. The method of claim 1, wherein the step of combining further comprises embedding the advertisement with the product-related information.

3. The method of claim 1, wherein the step of obtaining product-related information is a function of at least one of a user characteristic, a product characteristic, and an environmental metric.

4. The method of claim 1, wherein the one or more user characteristics further includes at least one of user age, a user gender, and a user membership in a loyalty program.

5. The method of claim 1, wherein the product characteristic is at least one of a product cost, a product quantity per unit, and a product remaining shelf life.

6. The method of claim 1, wherein the environmental metric is at least one of a time of day, a weather condition, and a special event.

7. The method of claim 1, wherein the step of assigning is at least partially based on at least one of a physical proximity metric and a market overlap metric.

8. The method of claim 1, wherein the step of determining a winning advertiser is at least partially based on at least one of a physical proximity metric and a market overlap metric.

9. The method of claim 1, wherein the step of determining a winning advertiser is at least partially based on a result of an auction.

10. The method of claim 1 wherein the product-related information comprises a recipe.

11. The method of claim 1 wherein the product-related information comprises a coupon.

12. A method of monetizing an interaction in which a user utilizes a user device to select a product, comprising:
obtaining product-related information associated with the product;
analyzing one or more user characteristics, wherein the one or more user characteristics include historical user purchase behavior associated with a user purchase history;
extracting at least one purchasing pattern of a user;
determining a predicted future user purchasing behavior based on the extracted at least one purchasing pattern of the user;
filtering one or more advertisers based on the predicted future user purchasing behavior to select one or more user-relevant advertisers, wherein the selected one or more user-relevant advertisers at least includes a first advertiser and a second advertiser;
assigning at least the first advertiser and the second advertiser to an advertising space auction;
determining a winning advertiser from among at least one of the first and the second advertiser;
receiving an advertisement associated with the winning advertiser;
combining (a) at least some of the product-related information and (b) the advertisement into a response; and
sending the response to the device of the user.

13. The method of claim 1, wherein the step of combining further comprises embedding the advertisement with the product-related information.

14. The method of claim 1, wherein the step of obtaining product-related information is a function of at least one of a user characteristic, a product characteristic, and an environmental metric.

15. The method of claim 1, wherein the one of more user characteristics further includes at least one of a user age, a user gender, and a user membership in a loyalty program.

16. The method of claim 1, wherein the product characteristic is at least one of a product cost, a product quantity per unit, and a product remaining shelf life.

17. The method of claim 1, wherein the environmental metric is at least one of a time of day, a weather condition, and a special event.

18. The method of claim 1, wherein the step of assigning is at least partially based on at least one of a physical proximity metric and a market overlap metric.

19. The method of claim 1, wherein the step of determining a winning advertiser is at least partially based on at least one of a physical proximity metric and a market overlap metric.

20. The method of claim 1, wherein the step of determining a winning advertiser is at least partially based on a result of an auction.
